(19) United States
(12) Patent Application Publication
(10) Pub. No.: US 2003/0191650 A1
(43) Pub. Date: Oct. 9, 2003

(54) CUSTOMIZED UPGRADING OF INTERNET-ENABLED DEVICES BASED ON USER-PROFILE

(75) Inventors: ADRIAN J. TURNER, SUNNYVALE, CA (US); SIMON PEARCE, ATLANTA, GA (US); DAVID ANTHONY EVES, WEST GREEN (GB); ALLAN ROGER TIMMS, MERSTHAM (GB)

Correspondence Address: CORPORATE PATENT COUNSEL, PHILIPS ELECTRONICS NORTH AMERICA CORPORATION, 580 WHITE PLAINS ROAD, TARRYTOWN, NY, 10591, US

(73) Assignee: PHILIPS ELECTRONICS NORTH AMERICA CORPORATION

(21) Appl. No.: 09/160,490

(22) Filed: Sep. 25, 1998

(51) Int. Cl. G06F 17/60

(52) U.S. Cl. 705/1

(57) ABSTRACT

A server system maintains a user profile of a particular end-user of consumer electronics network-enabled equipment and a data base of new technical features for this type of equipment. If there is a match between the user-profile and a new technical feature, and the user indicates to receive information about updates or sales offers, the user gets notified via the network of the option to obtain the feature.

### FIELD OF THE INVENTION

The invention relates to a method of providing an Internet service to an end-user, in particular to an end-user of consumer electronics equipment.

### BACKGROUND ART

The Internet has given rise to several key market trends. These include the phenomenal, continued growth rates in Internet usage, with 30% of the US population online in 1998, a 75% increase over the year before. As more users emerge, their profiles are changing significantly. Today's average user has lower income and education levels than the average user of 2 years ago. Access devices are also changing, with International Data Corporation (IDC) projecting that the number of non-PC Internet enabled devices are likely to outnumber PC's inside of 7 years. Dataquest also projects that the growth rates for every class of non-PC Internet enabled device will outstrip growth rates in PC sales between now and 2001. Further, Internet enabled devices have come to rely on networks for new and exciting services.

Web-TV of Philips Magnavox is an example of a device that supports such an exciting synergy between the conventional TV on the one hand and the Internet on the other. The Philips Magnavox WebTV Plus Receiver offers a WebPIP (picture in picture) feature. Users can watch a television program simultaneously while maintaining a connection to the Web, even if their television set does not have PIP capability. This enables, for example, watching a TV show and being able to retrieve your E-mail at the same time without ever having to leave the living room couch. The receiver comes with an Electronic Program Guide (EPG) that allows users to receive text and video information about all the programs available on their TV system. The EPG is updated daily from the Web. The EPG is continuously available to the user while offline. Further expanding users' online capabilities, the integrated WebTV Crossover Links feature provides instant access to Web sites when users click on embedded links in television programs or commercials. For example, one could watch a TV documentary on the space program and simultaneously link up to the NASA Web site for additional information on a specific topic. Or, consumers shopping for a new car could click on the Web site link in an advertiser's TV commercial and instantly get more information on availability, options, and local dealers. Flash memory storage permits on-touch field upgradability of the on-board software and the downloading of new applications from the Internet in order to ensure constant compatibility with the ever-evolving technology.

### OBJECT OF THE INVENTION

Value is migrating from the device to the Network and Network Applications. The growth of the Internet into a ubiquitous medium, coupled with the convergence of PC and TV, will result in new products which have both PC and CE functionality but which also have a third component which is termed “connected functionality”. Networked or interconnected products will come to replace the idea of separate stand-alone products. This will have two significant consequences. A first consequence is that value to a consumer will shift from being “device-centric” to being “functionality-centric” or “taskcentric”. Voicemail is a good example of this. The access device is unimportant and the value of the messaging system is in the network. A second consequence is that the emphasis of the effort in the sales market to win the consumer's preference will change. With every device being connected or interconnected, bandwidth into the home increasing, and vast amounts of data made easily accessible, the new focus of an enterprise's effort is believed to be the interface with the consumer.

It is an object of the invention to further enhance the Internet services in view of the proliferation of Internet-enabled devices and ubiquitous connectivity. It is another object to let the user of consumer electronics devices benefit of the Internet in a novel manner.

### SUMMARY OF THE INVENTION

To this end, the invention provides a method of enabling customizing a technical functionality of network- (e.g., Internet-) enabled equipment of an end-user. According to the method a profile of the end-user and information about a technical feature for use with the equipment are stored at a server system. Based on the user-profile it is determined whether or not the user should be notified about the availability of this feature. If it has been decided that there is a match between the user profile as stored and the information about this feature, the end-user gets notified via the network of the option to obtain the feature for being added to his/her equipment. In case the feature relates to new software, it can be downloaded via the network for preferably automatic installation in the equipment. In case the feature comprises a hardware component, it can be shipped to the end-user upon acceptance of the offer. A helpdesk is preferably provided through the network to help the end-user install the feature.

The invention is based on the insight that network-enabled equipment will become a flexible repository into which the end-user can place new and exciting features over time dependent on the user's needs or desires, context of use, advancement of technology, etc. Not all end-users are always interested in all possible features for creating enhanced functionality of the equipment. Accordingly, a user-profile is established, either when the user registers his equipment with the notification service, or dynamically as a consequence of the user's interaction with the server system, or through a combination thereof. The profile is used to select technical features that are likely of interest to the user. In this manner, the user is kept abreast of the latest trends of interest to him/her. The invention implicitly supports virtual recycling as equipment needs to be designed for the purpose of being upgraded. The modular approach of adding or deleting technical software or hardware features as needed thus assists in slowing down the trend that products becoming obsolete fairly quickly, but without barring the manufacturer or aftermarket sales organizations from continuing doing business.

The invention is specifically relevant to vertical markets. A vertical market is a particular branch of commercial activity for which similar products or similar services are relevant. Examples of vertical markets are education, offices, hotels, consumers, hospitals, etc. Each of these segments have unique requirements for hardware devices and their functionality. Hardware manufacturers can make their devices more relevant to a specific vertical market segment by combining a relevant set of applications and services.

For completeness, reference is made to U.S. patent application Ser. No. 08/785,459(Attorney Docket PHA 23,217) filed Jan. 17, 1997 for “A METHOD FOR PERSONALIZING HOSPITAL INTRANET WEB SITES” describing a method of personalizing communication via the intranet based on declared interest, user environment and and technical constraints of the receiving equipment. in aforesaid application, it is the data content or service that is adapted to the user profile. In the current invention, it is the upgrading or modifying of a technical functionality of the equipment under user-profile control.

### BRIEF DESCRIPTION OF THE DRAWINGS

The invention is explained by way of example and with reference to the accompanying drawings, wherein:

FIG. 1 is a diagram of a system in the invention; and

FIG. 2 is a flow diagram of a method in the invention.

Throughout the figures, same reference numerals indicate similar or corresponding features.

### PREFERRED EMBODIMENTS

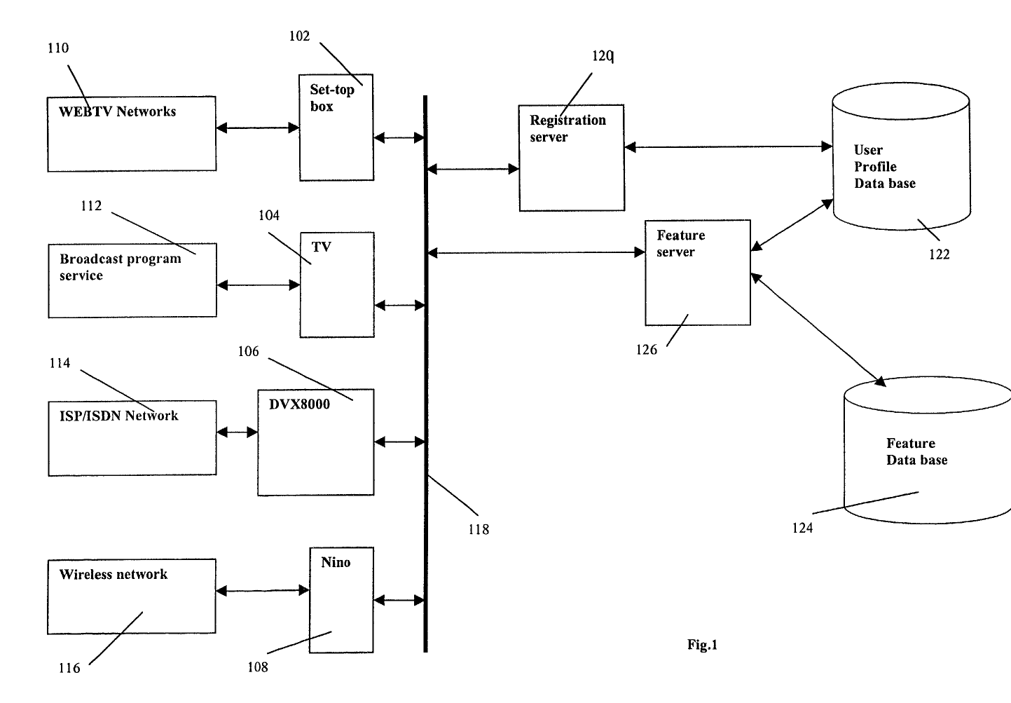

FIG. 1 is a block diagram of an information processing system 100 of the invention. System 100 comprises multiple CE devices of an end-user, such as a set-top box 102 (e.g., the WebTV of Philips Electronics), a TV receiver 104, a home entertainment sub-system 106 (e.g., the DVX8000 of Philips Electronics), and a PDA 108 (e.g., the Nino of Philips Electronics that has a wireless transceiver). Set-top box 102 comprises a device that enables television set 104 to become a user interface to the Internet. Set-top box 102 contains a Web browser (i.e., a Hypertext Transfer Protocol client) and the Internet's main program, TCP/IP. Set-top box 102 is connected to a service 110, e.g., through a telephone line as, for example, with WebTV. TV receiver 104 is connected to a data and video delivery service 112 such as contemplated by, e.g., the company TiVo. This start-up company has developed a data and video delivery service for a VCR that allows digital recording from TV scan for programs based on user preferences and enables customized ad delivery. The DVX8000 sub-system 106 is connected to an ISP or ISDN network 114. PDA 108 communicates via a wireless network 116 with other PDA's (not shown), with laptops (not shown), etc. Each of devices 102-108 is enabled to communicate via the Internet 118.

System 100 further comprises as a back-end architecture a registration server 120, a user-profile data base 122, a feature data base 124 and a feature management server 126. Server 120 registers user preferences of devices 102-108. Preferences may be explicitly supplied by the end-user in order to be registered at server 120 and/or implicitly derived from, e.g., a user-profile gradually built-up through relations with the hardware and/or service provider. User-preferences relate to, for example, context of use (e.g., profession, hobbies, home, office, hotel, school, college, airport, shopping mall), device characteristics, user-needs. Registration server 120 passes on to user-profile data base 122 the information about each particular end-user registered. Feature data base 124 contains information about new features, services and devices and is being kept up-to-date by the service provider, e.g., the manufacturer(s) of devices 102-108. For each particular end-user registered, feature management server 126 associates the user-profile as stored in data base 122 with features, devices and services, information about which is made available through feature data base 124 in order to notify the end-user of new features, devices or services, items on-sale, etc., that are likely to be of interest to the end-user given his/her profile. For example, server 126 notifies the end-user of new releases of software included in one of more of devices 102-108 in order to have these devices upgraded if and when desired and via, e.g., the Internet. The information about end-user's equipment 102-108 and their configuration is available through user-profile data base 122. As another example, server 126 notifies the end-user of new functionalities in terms of software applications and/or hardware components that can be added to one or more of devices 102-108 by way of upgrade. For example, assume that a new voice recognition software program and a voice input/output module have become available for one or more of devices 102-108. Since this end-user has been registered as owning devices 102-108, server 126 notifies this end-user of the possibility to have his/her equipment upgraded. The user may order the software and hardware modules through the Internet. He/she gets the software downloaded automatically if and when desired via the Internet. The hardware module is being shipped to the end-user together with clear instructions how to add this module to his/her equipment 102-108. Alternatively, or subsidiarily, server 126 also provides an online help desk for assisting the end-user with installing the new components. In this manner, an end-user's device has become a flexible repository into which the consumer/end-user can place new and exciting features over time. Since the notification is user-profile controlled, the end-user is enabled to customize his/her equipment in a guided manner. As another example, the end-user has specified a certain log-in shield when turning on a particular device or service, e.g., PDA 108. See for example, U.S. application Ser. No. 09/151,578 (Attorney docket PHA 23,496) “CONTEXT SENSITIVE LOG-IN SHIELD” of Bart de Greef, filed Sept. 11, 1998, and incorporated herein by reference. This reference relates to a login shield that controls access to a computer, a network system or another information processing system. The login shield provides for the selection of context and application options. At login, the user has the option to identify a context, from which the login shield identifies an initial workspace or set of workspaces. The login shield prompts the user for identification information and compares the identification information to a set of authorized users. If a match is found, the login shield establishes the initial workspace and launches the selected applications. The user is also provided a means to create and define alternative contexts for selection at login. By allowing the user to define and select among alternative contexts at the start of the login process, the overhead associated with the login process can be minimized to that required for each particular user context. Once this login shield has been specified for device 108, the user can specify that other devices 104-106 be set via server 126 to also provide a similar login shield. Thus, and in general, user-preferences can be transferred to other network-enabled devices of the end-user, and to future network-enabled devices when the user has connected them to the network.

Preferably, devices 102-108 enable the user to contact the back-end architecture (servers 120 and 126) through a consistent UI, e.g., a standardized GUI on a display of one or more devices 102-108 or on a remote control, e.g., the programmable universal remote controller “Pronto” of Philips Electronics, which has an LCD with a resolution high enough for this purpose. Preferably, the UI provides a standardized single key to start with a single touch communication with the back-end architecture in order to simplify user-interaction and to motivate users to enquire about what is new and available to them. If there is more than one user for equipment 102-108 further information processing may be necessary for selective personalization.

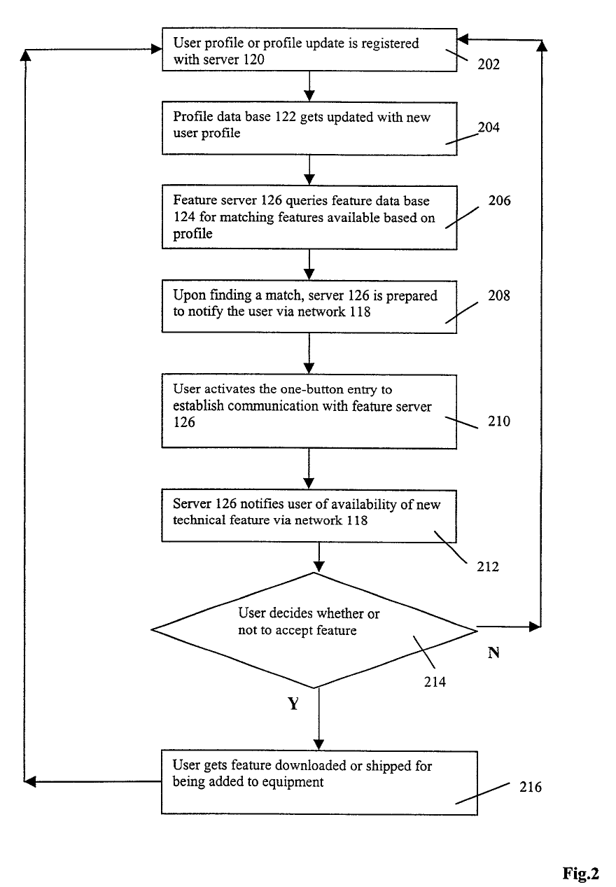

FIG. 2 is a flow diagram 200 illustrating various aspects of the method according to the invention. In step 202, the user-profile, or its update as the case may be, is registered with registration server 120. For example, registration is done explicitly by the user by providing information about context of use, device characteristics, personal interests, etc. Alternatively, or subsidiarily, the registration is accomplished automatically upon the user connecting the equipment to network 118 for the first time or since a particular time interval has elapsed. In the latter case, registration is limited to device characteristics and possibly the site through a device identifier and site identifier. In step 204, server 120 stores the profile or its update in data base 122. In step 206, feature server 126 queries feature data base 124 in order to determine if the user as registered should be notified of a new feature that fits in with his/her registered equipment given his/her profile. Upon finding such a match in step 208, feature server 126 notifies the user of this feature in step 212 when the user has logged in on server system 120-126, e.g., through a specific one-button action at his/her equipment 102-108 in step 210. If the user decides in step 214 not to take advantage of this offer, the process returns to step 202 to update the user's profile in data base 122 with the information that this specific user is not interested in the feature found. If the user decides in step 214 to take advantage of the offer he/she gets, in step 216, the feature downloaded via network 118 if the feature is a software-controlled functionality or gets a notification that the feature will be shipped in case it comprises hardware. The process returns to step 202 for updating this user's profile with the information that he/she is interested in the feature found.

We claim:

1. A method of enabling customizing a functionality of network-enabled equipment of an end-user, the method comprising:
storing a profile of the end-user;
storing information about a technical feature for use with the equipment;
determining if the feature is relevant to the end user based on the feature's information and the userprofile; and
notifying the end-user via the network of the option to select the feature for being added to the equipment.

2. The method of claim 1, wherein the equipment comprises first and second network-enabled apparatus, the method comprising:
providing the feature for the first and second apparatus via the network upon the user having selected the feature.

3. The method of claim 1, wherein the feature comprises a software module downloadable via the network.

4. The method of claim 1, wherein the feature comprises a hardware module.
